(19) United States
(12) Patent Application Publication
(10) Pub. No.: US 2026/0298748 A1
(43) Pub. Date: Oct. 1, 2026

(54) PRESSURE SENSOR

(71) Applicant: Kistler Holding AG, Winterthur (CH)

(72) Inventor: Michael MUELLER, Schlatt (CH)

(21) Appl. No.: 19/629,141

(22) Filed: Mar. 26, 2026

(30) Foreign Application Priority Data
Mar. 27, 2025 (EP) 25166692.1

(51) Int. Cl. G01L 9/00; G01L 19/14

(52) U.S. Cl. CPC G01L 9/0089; G01L 19/14

(57) ABSTRACT

A pressure sensor for measuring the pressure of a medium in an interior of a pressure chamber defined by a wall including a measuring bore extending from outside of the pressure chamber into the interior. The pressure sensor includes a housing, a plunger element and a measuring element. The plunger element and the measuring element are arranged in a housing space of the housing. When the pressure sensor is mounted at the measuring bore, the plunger element extends within the housing space, wherein the pressure acts onto the plunger element, which is operatively connected to the measuring element and transmits the pressure onto the measuring element. An annular gap extends between the housing and the plunger element. A foil element seals the annular gap from the ingress of the medium.

### TECHNICAL FIELD

The invention relates to a pressure sensor configured to be mounted in a measuring bore of a wall of a pressure chamber for measuring the pressure of a fluid medium constrained in the pressure chamber of an injection molding tool or an internal combustion engine.

### BACKGROUND OF THE INVENTION

Pressure sensors are used in a wide variety of technical applications. The document WO2006/032152A1, which corresponds to applicant’s commonly owned US Patent Application Publication No. 2007-0277617 that is by this reference hereby incorporated herein in its entirety for all purposes, illustrates a pressure sensor for measuring the pressure prevailing in a pressure chamber of an injection molding tool or an internal combustion engine. Said pressure sensor comprises a housing, a plunger and a measuring element. The housing comprises a housing space, in which housing space are arranged the plunger and the measuring element. Via the housing, the pressure sensor can be mounted in a measuring bore in a wall of the pressure chamber. When the pressure sensor is mounted in the measuring bore, the plunger protrudes with a first end thereof from the housing into the pressure chamber. With a second end, the plunger is operatively connected to the measuring element. In this way, the pressure to be measured is transmitted via the plunger onto the measuring element.

In the case of an injection molding tool, the medium present in the pressure chamber is a liquid melt of plastic, metal and the like material, while in the case of an internal combustion engine it is a fuel-air mixture. The medium may have a temperature of several hundred ° C and a pressure of several hundred bars. For achieving a high sensitivity of the pressure sensor during pressure measurement, the plunger is disposed movably with respect to the housing which is achieved by an annular gap between the housing and the plunger. To prevent the medium from penetrating through the annular gap into the housing space and from damaging or destroying the measuring element therein, the document WO2006/032152A1 teaches to provide a metallic annular diaphragm in the annular gap, which annular diaphragm is attached to the plunger and to the housing by means of a welded connection, thus, sealing the annular gap.

However, a force shunt is created by the welded connection of the annular diaphragm, due to which force shunt a portion of the pressure to be measured is diverted from the plunger into the housing, thus reducing the sensitivity of the pressure sensor during pressure measurement. Particularly for high pressures of more than 1000 bars, the annular diaphragm is made thick enough to ensure a long service life, however, this results in a significant force shunt. Furthermore, the annular diaphragm that is welded to the housing and to the plunger forms an oscillating system, which becomes excited to generate oscillations during pressure measurement, which oscillations may lead to distortion of the pressure measurement. Finally, the location of the welded connection of the annular diaphragm in the annular gap is sufficiently difficult to access with a welding tool such that making the welded connection becomes laborious and expensive.

### OBJECTS AND SUMMARY OF THE INVENTION

It is therefore an object of the present invention to provide a pressure sensor that measures the pressure to be measured with high sensitivity and high accuracy. In particular, the pressure sensor shall also be able to measure high pressures of more than 1000 bars with high sensitivity and high accuracy.

This object is achieved by the features described below.

The invention relates to a pressure sensor for measuring the pressure of a medium in a pressure chamber that is enclosed in a pressure-tight manner by a wall, which defines a measuring bore configured to extend from outside of the pressure chamber up to the pressure chamber. The pressure sensor is generally configured to elongate along a longitudinal axis and comprises a housing, a plunger element and a measuring element. The housing defines a housing space and a housing opening providing access into the interior of the housing space. The plunger element and the measuring element are arranged in the interior of the housing space. The pressure sensor is configured to be mounted at the measuring bore, and when the pressure sensor is so mounted, the housing projects from outside of the pressure chamber into the measuring bore with a housing end that is disposed close to the pressure chamber, and the housing opening is arranged at the housing end that is disposed close to the pressure chamber. The plunger element is configured to extend within the housing space in a longitudinal direction of the pressure sensor up to the housing opening, wherein the pressure can act through the housing opening on the plunger element, which is operatively connected to the measuring element in a manner that transmits the pressure onto the measuring element. Due to the relative dispositions of the housing and the plunger element, an annular gap is defined so as to extend in the longitudinal direction in the housing space between the housing and the plunger element. At least one foil element is attached to the end of the housing that is close to the pressure chamber and configured to seal the annular gap against the ingress of medium into the housing space where the measuring element is disposed.

In contrast to the teachings of WO2006/032152A1, the annular gap is sealed against the medium by the foil element so that during operation of the pressure sensor, none of the medium can penetrate into the annular gap. In particular, at high pressures of more than 1000 bars, this foil element is configured and disposed so as to prevent any of the medium from penetrating into the annular gap and from settling there. This is because were the medium to become deposited in the annular gap, the medium so deposited may adhere to the plunger and impair the movement of the plunger. The impaired movement of the plunger, in turn, reduces the sensitivity of the pressure sensor.

Advantageous embodiments of the objects of the invention are explained more fully below.

### BRIEF DESCRIPTION OF THE DRAWINGS

In the following, the invention is explained in more detail with reference to the figures in which:

FIG. 1 shows a cross-section through a portion of a first embodiment of a pressure sensor 10 according to the invention comprising a disc-shaped foil element 14 attached to a housing end 11.2 that is close to the pressure chamber and to a plunger element 12;

FIG. 2 shows a cross-section through a portion of a second embodiment of a pressure sensor 10 according to the invention comprising a disc-shaped foil element 14 attached only to the housing end that is close to the pressure chamber; and

FIG. 3 shows a cross-section through a portion of a third embodiment of a pressure sensor 10 according to the invention comprising a ring-shaped foil element 14’ attached to the housing end 11.2 that is close to the pressure chamber and to the plunger element 12, and additionally comprising a sealing element 15.

Like reference numerals denote identical objects in the figures.

### DETAILED DESCRIPTION OF EXEMPLARY EMBODIMENTS OF THE INVENTION

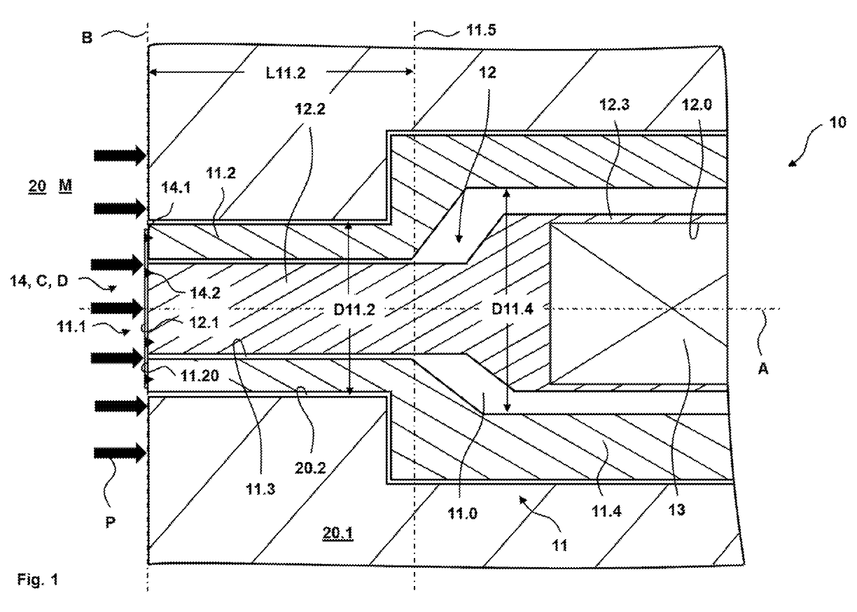

FIGS. 1-3 show cross-sections through portions of three embodiments of a pressure sensor 10 according to the invention. The cross-sections are taken along a longitudinal axis A of the pressure sensor 10. Hereinafter, a direction parallel to the longitudinal axis A is referred to as the longitudinal direction. A direction perpendicular to the longitudinal axis A is referred to as the radial direction.

### The Pressure Chamber 20

The pressure sensor 10 is configured to perform the function of measuring the pressure P of a medium M in a pressure chamber 20.

The pressure chamber 20 may be located in an injection molding tool, in an internal combustion engine and the like. The pressure chamber 20 is at least partially defined by a wall 20.1 that mediates between an interior of the pressure chamber and what is kept outside of the interior of the pressure chamber 20. The wall 20.1 is made of a corrosion-resistant metallic material such as high-alloy stainless steel. The wall 20.1 is configured to enclose the interior of the pressure chamber 20 in a pressure-tight manner. As used in the present invention, the adjective "pressure-tight" means that the medium M cannot escape from the interior through the wall 20.1 to the outside of the pressure chamber 20. The pressure chamber 20 may be a storage container for the medium M, an injection molding tool containing the medium M, a component of an internal combustion engine containing the medium M, and the like.

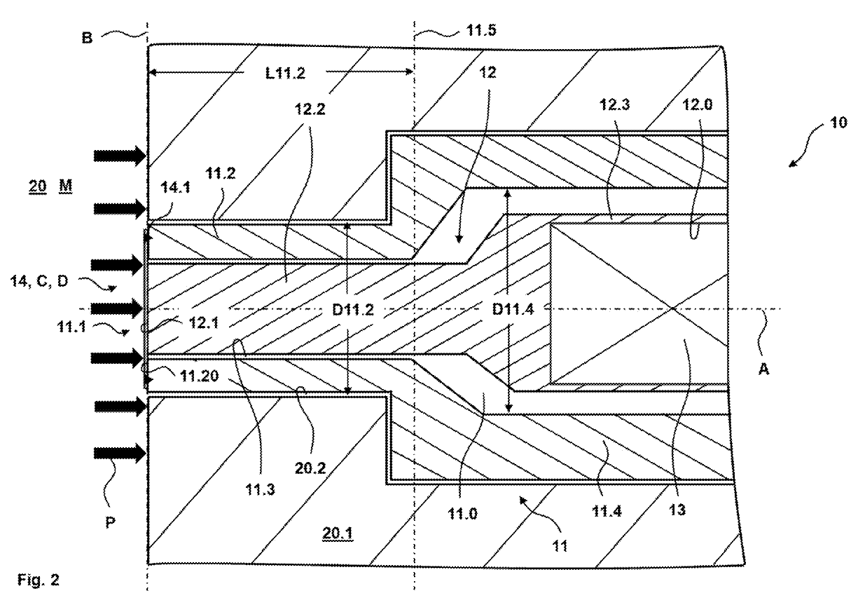

The medium M may be gaseous and/or liquid. In the case of an injection molding tool, the medium M is a liquid melt consisting of at least one material of plastic or metal. In the case of an internal combustion engine, the medium M is a fuel-air mixture. The medium M may reach a high temperature of several hundred ° C and attain a pressure P of several thousand bars. Preferably, the temperature is in the range of 100° C to 500° C, and the pressure P is in the range of 50 bars to 5000 bars. In FIGS. 1 and 2, the pressure P to be measured is schematically shown as thick black arrows.

For measuring the pressure P, the wall 20.1 defines a measuring bore 20.2. The measuring bore 20.2 is a through-hole which extends in the longitudinal direction from outside of the pressure chamber 20 up to the pressure chamber 20. Within the pressure chamber 20, the measuring bore 20.2 terminates in a pressure-receiving plane B of the wall 20.1.

The pressure sensor 10 comprises a housing 11, a plunger element 12, and at least one measuring element 13.

### The Housing 11

The housing 11 is configured to perform a first function of providing for mounting the pressure sensor 10 in the measuring bore 20.2 of the wall 20.1 of the pressure chamber 20. The housing 11 is configured to perform a second function of accommodating the plunger element 12 and the measuring element 13.

The housing 11 is made of a corrosion-resistant metallic material such as high-alloy stainless steel. The housing 11 is hollow-cylindrical in shape. As shown in FIGS. 1-3, the housing 11 extends in the longitudinal direction. The housing 11 defines a housing space 11.0 in the interior of the housing 11. The housing space 11.0 is bounded by the material of the housing 11 in the radial direction. The plunger element 12 and the measuring element 13 are arranged in the housing space 11.0.

The housing 11 includes a mounting means. The mounting means is configured to provide a mechanical connection to the wall 20.1. The mounting means may be a screw connection. The mounting means is not shown in the Figures.

The housing 11 defines a housing end 11.2 and a housing region 11.4. The housing end 11.2 and the housing region 11.4 transition into each other in a housing transition area 11.5. The housing end 11.2 and the housing area 11.4 are made of the same material as the housing 11. When the pressure sensor 10 is mounted, the housing 11 projects from outside of the pressure chamber 20 into the measuring bore 20.2 with the housing end 11.2 and is in contact with the medium M. Therefore, the housing end 11.2 is also referred to as the housing end 11.2 that is close to the pressure chamber. The housing end 11.2 close to the pressure chamber has an external diameter D112. Preferably, the diameter D112 of the housing end 11.2 close to the pressure chamber is circular in shape about the longitudinal axis. The housing end 11.2 close to the pressure chamber terminates in an annular-shaped housing abutment surface 11.20.

A housing opening 11.1 is arranged at the housing end 11.2 close to the pressure chamber. The housing opening 11.1 is bounded by the housing abutment surface 11.20 in the radial direction. The plunger element 12 is subject to the pressure P applied by the medium M through the housing opening 11.1. As shown in FIGS. 1-3, the housing end 11.2 close to the pressure chamber 20 together with the housing abutment surface 11.20 and the housing opening 11.1 is in the pressure-receiving plane B. Preferably, but not necessarily, the pressure-receiving plane B extends in the radial direction perpendicularly to the longitudinal direction. Those skilled in the art knowing the present invention are able to design the pressure-receiving plane at any angle oblique to the longitudinal axis of the pressure sensor.

The housing end 11.2 close to the pressure chamber has a length L11.2. The length L11.2 of the housing end 11.2 close to the pressure chamber extends in the longitudinal direction from the pressure-receiving plane B up to the housing transition region 11.5.

When the pressure sensor 10 is mounted, the housing region 11.4 is located remote from the pressure chamber 20 and, therefore, is also referred to as the housing region 11.4 remote from the pressure chamber. The housing region 11.4 remote from the pressure chamber has a diameter D11.4. Preferably, the diameter D114 of the housing end 11.4 remote from the pressure chamber is circular in shape about the longitudinal axis. As shown in FIGS. 1-3, the diameter D11.2 of the housing end 11.2 close to the pressure chamber 20 in the radial direction is smaller than the diameter D11.4 of the housing region 11.4 remote from the pressure chamber 20.

### The Plunger Element 12

The plunger element 12 is configured to perform a first function of receiving the pressure P to be measured and of transmitting that pressure P onto the measuring element 13. The plunger element 12 is configured to perform a second function of preventing mechanical stresses that originate from the fastening of the pressure sensor 10 in the bore 20.2 of the wall 20.1 from being transmitted from the housing 11 onto the measuring element 13, since such mechanical stresses may distort the measurement of the pressure P.

The plunger element 12 is made of a corrosion-resistant metallic material such as high-alloy stainless steel. As shown in FIGS. 1-3, the plunger element 12 extends on the longitudinal axis A.

The plunger element 12 defines a plunger body 12.2 and a plunger sleeve 12.3. Preferably, but not necessarily, the plunger body 12.2 and the plunger sleeve 12.3 are manufactured in one piece from the same material as the plunger element 12. The plunger body 12.2 and the plunger sleeve 12.3 are arranged in the housing space 11.0 that is surrounded by the housing region 11.4 remote from the pressure chamber.

The plunger body 12.2 is cylindrical in shape and desirably is solid rather than hollow. The plunger sleeve 12.3 is hollow-cylindrical in shape and radially encloses a plunger sleeve space 12.0 that elongates along the longitudinal axis A. The measuring element 13 is arranged within the plunger sleeve space 12.0.

The plunger element 12 extends in the housing space 11.0 in the longitudinal direction up to the housing opening 11.1 at the housing end 11.2 that is close to the pressure chamber. The plunger element 12 defines a plunger abutment surface 12.1. Preferably, the plunger abutment surface 12.1 is circular in shape. According to FIGS. 1 and 2, the plunger element 12 terminates in the housing opening 11.1 by the plunger abutment surface 12.1. Preferably, but not necessarily, the plunger abutment surface 12.1 lies in the pressure-receiving plane B.

The plunger element 12 is in contact with the pressure P applied by the medium M via the plunger abutment surface 12.1. The pressure P to be measured acts onto the plunger abutment surface 12.1. The plunger abutment surface 12.1 absorbs the pressure P. The plunger element 12 is operatively connected to the measuring element 13 via the plunger body 12.2 and transmits the pressure P in the longitudinal direction onto the measuring element 13. For this purpose, the plunger element 12 is arranged in the housing space 11.0 movably in the longitudinal direction, both toward and away from the pressure chamber 20.

Preferably, the diameter D11.2 of the housing end 11.2 close to the pressure chamber 20 is less than or equal to 2 mm, preferably less than or equal to 4 mm. With such a small diameter of the housing end 11.2 close to the pressure chamber 20, the plunger abutment surface 12.1 occupies only a minimum space for receiving the pressure P. The relatively small area defined by the plunger abutment surface 12.1 in the configuration of the present invention is of particular importance for the ease of mounting the pressure sensor 10 in the measuring bore 20.2, especially in light of the restricted space in an injection molding tool or in an internal combustion engine.

The outermost cylindrical surface defining the plunger body 12.2 of the plunger element 12 is arranged in the housing space 11.0 spaced apart in the radial direction from the innermost surface defining the housing end 11.2 close to the pressure chamber 20 of the housing 11 by an annular gap 11.3. The annular gap 11.3 extends within the housing space 11.0 in the longitudinal direction between the housing 11 and the plunger element 12. When the pressure sensor 10 is mounted, the annular gap 11.3 substantially prevents mechanical stresses that originate from the mounting of the pressure sensor 10 to the wall 20.1 by the mounting means 2 from being transmitted onto the measuring element 13 via the housing 11. The annular gap 11.3 extends within the housing space 11.0 up to the housing opening 11.1.

### The Measuring Element 13

The measuring element 13 is configured to perform the function of generating a measurement signal for the pressure P to be measured.

The measuring element 13 may be a piezoelectric measuring element, a piezoresistive measuring element, a strain gauge and the like. A magnitude of the measurement signal is proportional to the pressure P measured. The measurement signal is transmitted for evaluation to an evaluation unit that is not shown in the Figures.

Preferably, the diameter D11.4 of the housing region 11.4 remote from the pressure chamber 20 is at least twice as large as the diameter D11.2 of the housing end 11.2 close to the pressure chamber 20. The measuring element 12 is arranged in the housing region 11.4 remote from the pressure chamber 20. The diameter D11.4 of the housing region 11.4 remote from the pressure chamber 20 that is large compared to the diameter D11.2 of the housing end 11.2 close to the pressure chamber 20 has the advantage that a measuring element of a correspondingly large size can be used. Thus, assuming that the sensitivity of the measuring element 12 increases with increasing the size thereof, the pressure measurement is carried out with high sensitivity while at the same time the plunger abutment surface 12.1 at the housing end 11.2 close to the pressure chamber 20 occupies only a minimum space.

Preferably, the length L11.2 of the housing end 11.2 close to the pressure chamber 20 is at least ten times as large as the diameter D11.2 of the housing end 11.2 close to the pressure chamber 20. The length L11.2 of the housing end 11.2 close to the pressure chamber 20 that is large compared to the diameter D11.2 of the housing end 11.2 close to the pressure chamber 20 has the advantage that the impact of the high temperature of several hundred ° C of the medium M on the measuring element 13 is attenuated by the limited thermal conductivity of the material of the plunger element 12. Preferably, the length L11.2 of the housing end 11.2 close to the pressure chamber 20 is designed to be such that the high temperature of the medium M has no negative impact on the measuring element 13. As used in the present invention, the adjective “negative” is intended to mean a distortion of the measurement signal and/or shortening of the service life of the measuring element 13. Thus, components of the measuring element 13 may outgas at high temperatures, and said gases may crosslink locally at electrical contact surfaces of the measuring element 13 and may form deposits there. Furthermore, high temperatures may lead to diffusion of base metals and to local deposition of oxide layers at the electrical contact surfaces of the measuring element 13. These effects may occur individually or in combination. As a result, the electrical resistance of the transmission of the measurement signal may change. The electrical contact resistance may increase by several orders of magnitude from the mΩ range into the MΩ range and accordingly distort the measurement signal and thus cause incorrect evaluations of the measurement signal. Generally, it is very important to ensure electrical insulation of the measurement signal transmission line also at high temperatures because electrical leakage currents may occur at components of the measuring element 13 that may also distort the transmission of the measurement signal. Furthermore, at high temperatures, different coefficients of expansion of the components of the measuring element 13 may lead to local mechanical stresses, which should be avoided if possible. Finally, high temperatures may lead to premature aging of the components of the measuring element 13.

### The Foil Element 14, 14'

According to the invention, the pressure sensor 10 includes at least one foil element 14, 14’.

The foil element 14, 14’ is configured to perform the function of sealing the annular gap 11.3 against the ingress of medium M into the housing space 11.0. As used in the invention, the verb "seal" means that during operation of the pressure sensor 10, medium M is not able to penetrate into the annular gap 11.3.

The foil element 14, 14’ is made of a corrosion-resistant metallic material such as high-alloy stainless steel.

The foil element 14, 14’ has a planar extension C measured parallel to the pressure-receiving plane B and a thickness D measured along the longitudinal axis A. According to FIGS. 1-3, the planar extension C of the foil element 14, 14’ is parallel to the radial direction, and the thickness D of the foil element 14, 14’ extends parallel to the longitudinal direction. Preferably, the planar extension C of the foil element 14, 14’ is at least one order of magnitude larger than the thickness D of the foil element 14, 14’. Preferably, the thickness D of the foil element 14, 14’ is less than or equal to 100 µm, preferably less than or equal to 50 µm, preferably less than or equal to 25 µm.

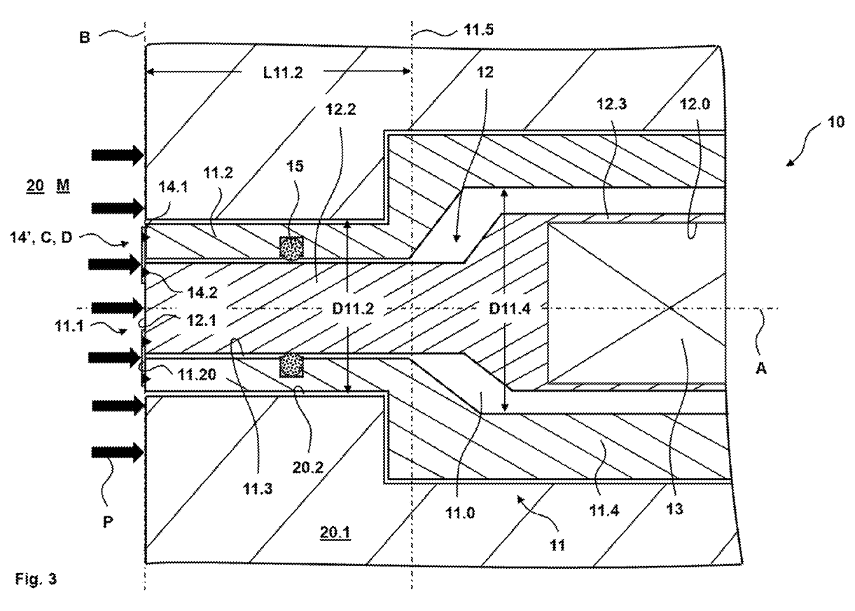

In the first and second embodiments of the pressure sensor 10 as shown in FIGS. 1 and 2, the foil element 14 is disc-shaped. In the third embodiment of the pressure sensor 10 as shown in FIG. 3, the foil element 14’ is ring-shaped.

The foil element 14, 14’ is configured and disposed so as to seal the housing opening 11.1 and the annular gap 11.3 against the ingress of medium M into the annular gap 11.3. Preferably, the foil element 14, 14’ is arranged to lie in the pressure-receiving plane B. Preferably, the foil element 14, 14’ defines a first region and a second region.

The foil element 14, 14’ is configured and disposed to permanently seal the annular gap 11.3 in a pressure-tight manner at temperatures in the range from 100° C to 500° C and at a pressure P in the range from 50 bars to 5000 bars.

In all three embodiments of the pressure sensor 10 as shown in FIGS. 1-3, the foil element 14, 14’ is attached to the housing end 11.2 that is close to the pressure chamber 20. Preferably, the foil element 14, 14’ is attached at the housing end 11.2 close to the pressure chamber 20 in the pressure-receiving plane B. Preferably, the foil element 14,14’ is attached with its first region to the housing abutment surface 11.20 of the housing end 11.2 close to the pressure chamber 20.

In the second embodiment of said pressure sensor 10 as shown in FIG. 2, the disc-shaped foil element 14 is attached only to the housing end 11.2 close to the pressure chamber 20. In this case, since the foil element 14 is not attached to the plunger element 12, the movability of the plunger element 12 is not impaired by the foil element 14 when the pressure P is measured and, thus, the sensitivity of the pressure sensor 10 is not reduced. Furthermore, since the disc-shaped foil element 14 is not attached to the plunger element 12, the disc-shaped foil element 14 is not deflected by the movement of the plunger element 12. Particularly at a high pressure P of up to 5000 bars and with a disc-shaped foil element 14 having a small thickness, a deflection of the disc-shaped foil element 14 may lead to undesirable plastic deformation of the disc-shaped foil element 14, and thus may shorten the service life of the pressure sensor 10.

In the first and third embodiments of the pressure sensor 10 as shown in FIGS. 1 and 3, the foil element 14, 14’ is additionally attached to the plunger element 12. Preferably, the foil element 14, 14’ is attached at the housing end 11.2 close to the pressure chamber 20 and to the plunger element 12 in the pressure-receiving plane B. Preferably, the foil element 14, 14’ is attached with its first region to the housing abutment surface 11.20 of the housing end 11.2 close the pressure chamber 20 and with its second region to the plunger abutment surface 12.1 of the plunger element 12. When the foil element 14, 14’ is additionally secured to the plunger element 12, a mechanically stable and permanent fit of the foil element 14, 14’ is ensured when it closes off and seals the annular gap 11.3 against the ingress of medium M.

The foil element 14, 14’ is secured by means of a material-bonded connection. Said material-bonded connection is formed by a welded joint 14.1, 14.2 as shown in FIGS. 1-3. The welded joint 14.1, 14.2 includes a first welded joint 14.1 and a second welded joint 14.2.

In the second embodiment of the pressure sensor 10 according to FIG. 2, only the first welded joint 14.1 secures the first region of the disc-shaped foil element 14 to the housing abutment surface 11.20 of the housing end 11.2 close the pressure chamber 20. The first welded joint 14.1 is preferably ring-shaped when viewed in the pressure-receiving plane B.

In the first and third embodiments of the pressure sensor 10 according to FIGS. 1 and 3, the first welded joint 14.1 secures the first region of the foil element 14, 14’ to the housing abutment surface 11.20 of the housing end 11.2 close the pressure chamber 20, and the second welded joint 14.2 secures the second region of the foil element 14, 14’ to the plunger abutment surface 12.1 of the plunger element 12. The first welded joint 14.1 is preferably ring-shaped, while the second welded joint 14.2 is preferably ring-shaped or spot-shaped.

### The Sealing Element 15

The third embodiment of the pressure sensor 10 according to FIG. 3 also includes at least one sealing element 15.

The sealing element 15 is configured to perform the function of sealing the annular gap 11.3 in addition to the sealing provided by the foil element 14, 14’. The additional sealing of the annular gap 11.3 by the sealing element 15 ensures that, in the event of breakage or cracking of the foil element 14, 14’, the medium M does not penetrate into the housing space 11.0 through the annular gap 11.3 and damage or destroy the measuring element 13 therein. The additional sealing of the annular gap 11.3 by the sealing element 15 is not essential for the purposes of the invention.

The sealing element 15 desirably is arranged in a groove defined in the housing end 11.2 close to the pressure chamber 20.

The groove is arranged radially and circumferentially into the inside surface of the housing end 11.2 close to the pressure chamber 20 with respect to the longitudinal axis A. The groove desirably is ring-shaped. The groove defines a plurality of groove walls, which are contiguous but may lie in different planes of orientation. As shown in FIG. 3, the groove is rectangular in cross-section. The groove is open in the radial direction towards the annular gap 11.3 and the plunger element 12. Those skilled in the art and knowing the present invention can also implement the groove with other groove geometries such as with a triangular cross-section, with a trapezoidal cross-section, with a round cross-section, with a semicircular cross-section and the like.

The sealing element 15 is toroidal in shape and consists of an elastically sealing material such as an elastomer, in particular a fluoroelastomer or perfluoroelastomer, of rubber, in particular of acrylonitrile butadiene rubber, and the like.

The sealing element 15 arranged in the groove seals the annular gap 11.3 against the plunger element 12 by means of sealing pressure. The sealing pressure may act as an axial sealing pressure in the longitudinal direction or as a radial sealing pressure perpendicularly in the radial direction or as a combination of an axial sealing pressure in the longitudinal direction and a radial sealing pressure in the radial direction.

Preferably, the sealing element 15 is arranged in the groove under pre-compression. The pre-compression is exerted onto the sealing element 15 by the groove walls. In the event of breakage or cracking of the foil element 14, 14’, the medium M enters into the annular gap 11.3, and the pressure P of the medium M in the annular gap 30.4 will act onto the sealing element 15 as a pressing force in addition to the pre-compression. In this case, sealing of the annular gap 11.3 is achieved by the pressing force in addition to the sealing pressure and the pre-compression.

The sealing element 15 may be arranged a few millimeters away from the housing abutment surface 11.20 in the longitudinal direction having the advantage that a low-viscosity medium M is prevented from penetrating far into the annular gap 11.3 before it is blocked by the sealing element 15.

In addition, the sealing element 15 may be arranged a few centimeters away from the housing abutment surface 11.20 in the longitudinal direction having the advantage that in the case of a high-temperature medium M, the sealing element 15 will not be exposed to the high temperature of the medium M during operation of the pressure sensor 10 since the temperature in the wall 20.1 and, thus, also in the housing end 11.2 close to the pressure chamber 20 decreases with increasing distance from the pressure chamber 20.

The sealing element 15 permanently seals the annular gap 11.3 in a pressure-tight manner at a temperature ranging from 100° C to 500° C and at a pressure P ranging from 50 bars to 5000 bars.

Those skilled in the art and knowing the present invention may implement a plurality of grooves in the housing end close to the pressure chamber for a plurality of sealing elements 15.

Those skilled in the art and knowing the present invention are able to combine the three embodiments of the pressure sensor 10 according to FIGS. 1-3 with each other. Thus, also the first and second embodiments of the pressure sensor as shown in FIGS. 1 and 2 may comprise a sealing element.

### LIST OF REFERENCE SYMBOLS

10 Pressure sensor
11 Housing
11.0 Housing space
11.1 Housing opening
11.2 Housing end close to the pressure chamber
11.20 Housing abutment surface
11.3 Annular gap
11.4 Housing region remote from the pressure chamber
11.5 Housing transition area
12 Plunger element
12.1 Plunger abutment surface
12.2 Plunger body
12.3 Plunger sleeve
12.0 Plunger sleeve space
13 Measuring element
14, 14’ Foil element
14.1 First welded joint
14.2 Second welded joint
15 Sealing element
20 Pressure chamber
20.1 Wall
20.2 Measuring bore
A Longitudinal axis
B Pressure-receiving plane
C Extension
D Thickness
D11.2 Diameter of housing end close to pressure chamber
D11.4 Diameter of housing area remote from pressure chamber
L11.2 Length of housing end close to pressure chamber
M Medium
P Pressure

What is claimed is:

1. A pressure sensor for measuring the pressure of a medium in a pressure chamber that includes a wall defining a measuring bore that is configured to extend from outside the pressure chamber into the pressure chamber, the pressure sensor comprising:
a housing that elongates along a longitudinal axis and defines a housing space contiguous with a housing opening, wherein the housing defines a housing end at one opposite end of the housing, and the housing opening is disposed at the housing end, which is configured to project into the measuring bore from outside the pressure chamber when the sensor is mounted at the mounting bore of the pressure chamber;
a measuring element disposed in the housing space;
a plunger element disposed in the housing space and elongating along the longitudinal axis up to the housing opening, wherein the plunger element is operatively configured to transmit to the measuring element, the pressure of the medium in the pressure chamber;
wherein the housing and plunger element are configured and disposed to define an annular gap between the housing and the plunger element, wherein the annular gap extends in the longitudinal direction in the housing space; and
a foil element attached to the housing end and configured and disposed to seal the annular gap against ingress of the medium into the annular gap.

2. The pressure sensor according to claim 1, wherein the annular gap extends in the housing space up to the housing opening.

3. The pressure sensor according to claim 1, wherein the foil element is configured to be disc-shaped.

4. The pressure sensor according to claim 1, wherein the foil element is configured to be ring-shaped.

5. The pressure sensor according to claim 1, wherein the foil element is defined by a planar extension and a thickness; and wherein the planar extension of the foil element is larger by at least one order of magnitude than the thickness of the foil element.

6. The pressure sensor according to claim 5, wherein the thickness of the foil element is less no more than 25 µm.

7. The pressure sensor according to claim 5, wherein the thickness of the foil element is less no more than 50 µm.

8. The pressure sensor according to claim 5, wherein the thickness of the foil element is less no more than 100 µm.

9. The pressure sensor according to claim 1, wherein the housing end defines a housing abutment surface to which the foil element is attached.

10. The pressure sensor according to claim 7, wherein the housing abutment surface lies in a pressure-receiving plane in which the foil element is arranged.

11. The pressure sensor according to claim 7, wherein the foil element is attached to the housing end by means of a material-bonded connection that is formed as a first welded joint that secures the foil element to the housing abutment surface.

12. The pressure sensor according to claim 1, wherein the housing end terminates in a housing abutment surface;
wherein the plunger element terminates in a plunger abutment surface;
wherein the foil element defines a first region and a second region spaced apart from the first region;
wherein the first region of the foil element is secured to the housing abutment surface of the housing end; and
wherein the second region of the foil element is secured to the plunger abutment surface of the plunger element.

13. The pressure sensor according to claim 10, wherein the plunger abutment surface of the plunger element lies in the pressure-receiving plane.

14. The pressure sensor according to claim 10, wherein the foil element is attached to the housing end and to the plunger element by means of a material-bonded connection;
wherein the material-bonded connection is formed as a welded joint that includes a first welded joint and a second welded joint;
wherein the foil element defines a first region and a second region spaced apart from the first region;
wherein the first welded joint secures the first region of the foil element to the housing abutment surface of the housing end; and
wherein the second welded joint secures the second region of the foil element to the plunger abutment surface of the plunger element.

15. The pressure sensor according to claim 10, wherein the pressure-receiving plane extends in a radial direction perpendicularly to the longitudinal direction.

16. The pressure sensor according to claim 1, further comprising a sealing element arranged in a groove, which is defined in the housing end and disposed close to the pressure chamber.

17. The pressure sensor according to claim 16, wherein the groove is open towards the annular gap and to the plunger element in the radial direction;
wherein the sealing element is toroidal in shape and made of an elastically sealing material; and
wherein when inserted in the groove, the sealing element is configured to seal the annular gap against the plunger element by a sealing pressure.

18. An injection molding tool comprising:
a pressure chamber that is configured to contain a medium under pressure and includes a wall defining a measuring bore that is configured to extend from outside the pressure chamber to the pressure chamber;
a pressure sensor mounted at the mounting bore of the pressure chamber, wherein the pressure sensor includes:
a housing that elongates along a longitudinal axis and defines a housing space contiguous with a housing opening, wherein the housing defines a housing end at one opposite end of the housing, and the housing opening is disposed at the housing end, which is configured to project into the measuring bore from outside the pressure chamber when the sensor is;
a measuring element disposed in the housing space;
a plunger element disposed in the housing space and elongating along the longitudinal axis up to the housing opening, wherein the plunger element is operatively configured to transmit to the measuring element, the pressure of the medium in the pressure chamber;
wherein the housing and plunger element are configured and disposed to define an annular gap between the housing and the plunger element, wherein the annular gap extends in the longitudinal direction in the housing space; and
a foil element attached to the housing end and configured and disposed to seal the annular gap against ingress of medium into the annular gap.

19. An injection molding tool as in claim 18, wherein the medium includes plastic material.

20. An injection molding tool as in claim 18, wherein the medium includes metallic material.
